(19) United States
(12) Patent Application Publication
(10) Pub. No.: US 2002/0147765 A1
(43) Pub. Date: Oct. 10, 2002

(54) Method of delivery of application modules over networks and monitoring thereof

(76) Inventors: Richard Scott Kaufman, Boca Raton, FL (US); Joseph Francisco Barrero, Lake Worth, FL (US)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 09/772,867

(22) Filed: Jan. 31, 2001

(51) Int. Cl. G06F 15/16; G06F 15/00

(52) U.S. Cl. 709/203; 707/513; 345/749

(57) ABSTRACT

Methods of delivering application modules over networks and monitoring those application modules are disclosed. A user requests a WEB page from a host site that includes embedded calls for the application modules. While the page is loaded on the user's machine, the application modules are loaded from a master site. The user interacts with the application modules and earns points depending on that interaction. The resulting points are dynamically sent to the master site where they are processed according to preset criteria, with the resultant information returned to the user in “real-time.” Methods of providing a point engine interface over networks and monitoring the interaction are disclosed. A user requests a WEB page from a host site that includes other possible means for a user to earn points than by interacting with the application modules as described above. Once the WEB page is returned, the user interacts with the page and earns points which are returned to the host site. The host site in turn contacts the master site through a unique code which directs the master site to award/adjust points accordingly. The information is processed and returned to the host site. Simultaneously, the master site makes this updated information available to the user through interaction with an application module.

### BACKGROUND OF THE INVENTION

1. Field of the Invention

The present invention relates generally to providing content over networks. The present invention relates to a method for delivering application modules over networks and monitoring the interactions between a user and those modules. More specifically, the present invention is directed to supplying a host WEB site with an application module, such as a game or other activity through which the user can earn points, and monitoring and maintaining an account for the user with regard to the points earned. The present invention is also directed to providing the host WEB site with the ability to award/adjust the user points for other actions than those provided in the aforesaid modules and having those points monitored and maintained within the user's account.

2. Description of the Related Art

The Internet has emerged as an important global medium, enabling millions of people worldwide to share information, communicate and conduct business electronically. The number of Internet users is expected to continue to grow, and the value of transactions on the Internet is also expected to increase. In addition, the number of users interacting over alternative networks, such as cellular phones, land based telephones and wireless electronic devices, is also expected to increase.

The Internet has become a tool for businesses to offer products and services that do not require the customer's physical presence to make a purchase decision. The Internet allows these businesses to develop relationships with customers worldwide without making significant investments in traditional infrastructure, i.e., “bricks and mortar,” such as retail outlets, distribution networks and sales personnel.

Historically, most advertising dollars were spent on mass advertising. In recent years, marketers have shifted their spending toward direct or targeted marketing activities. Direct marketing is the delivery of a customized message to a defined target audience. By using direct marketing, companies can measure the response to specific direct marketing programs or promotions and analyze the financial return on their marketing expenditures. Advertisers can use tools that are not available in traditional media, and these tools give advertisers rapid feedback on their marketing campaigns.

Direct marketing, especially promotions, sweepstakes and contests are designed to stimulate an immediate action from the consumer. This action could be in the form of a product sale or a request for further information. Promotions can also be used to alert the consumer about a new product or service.

With the present and expected growth in the Internet, the rapid proliferation of online direct promotional and relationship marketing is also expected to continue. In addition, the popularity of outsourced solutions under the application service provider model is also expected to increase.

There are a number of companies that currently offer direct promotional services in the form of sweepstakes, contests and promotions on the Internet. However, such prior art systems and promotions offered have several drawbacks.

First, the prior art promotions fail to provide “real-time” results to WEB users. Thus, if a user enters a promotion and receives some benefit, oftentimes that benefit is not conferred until the close of business or some other daily event. Thus, the benefits accrued by a user lack liquidity and are thus less attractive to the user without immediate feedback of “account” information.

Second, prior art promotions are often incongruous in appearance and character with the sites upon which they appear. A user to a WEB site often ignores what would be considered extraneous elements of the WEB site. Banner ads are often ignored, while content specific to the WEB site is the very reason that a user visits the WEB site. Elements of a WEB site that are blended seamlessly with the existing look and feel of the content on that WEB site receive greater attention.

Last, the administration of an account for a user that responds to a promotion must be maintained by a WEB site that provides the promotion. If the promotion provides a reward, the user receiving that reward must be monitored so that the reward can eventually be redeemed by the user for something useful. This is an added burden placed on the administration of the WEB site and can detract from other operations involved in maintaining the WEB site.

### SUMMARY OF THE INVENTION

Accordingly, it is an object of the present invention to provide to host sites with application modules that are able to offer “real-time” results to users. This is accomplished through the use of the application modules that are sent to the host site, while the administration of the user's account is maintained by a master site that provides immediate updates to the user.

Another object of the present invention is to provide application modules that seamlessly blend into, and have the look and feel of, the host site. The implementation process consists of providing the host site with simple cut-and-paste software or code, which also facilitates a rapid initial turnaround time. These application modules are hosted and maintained on the master site utilizing the host site as a medium of delivery, and are displayed on the host site through the use of a scripting language combined with a display language. Points are awarded to the end users through their actions involving the displayed application modules.

Another object of the present invention is to provide application modules through which points are rewarded that do not require a host site to monitor and maintain an accounting of those points. By “out-sourcing” promotions provided through the application modules, the host site is freed to focus on the other aspects of the WEB site and still have the benefits of the promotional application modules.

To achieve the above objects, according to a first aspect of the present invention, there is provided a method of delivering and monitoring application modules. That method begins when a user originates contact with the host WEB site. The host site replies by returning a page embedded with the application module(s) that encourage user interaction. When the user concludes the interaction with the application module, information is immediately sent to the master site based on said interaction. Finally, the information is processed and an account for the user, based on said information, is updated, with that updated account information being returned immediately to the user and displayed on his screen.

According to a second aspect of the present invention, a method is provided for a point engine interface whereby the points awarded/adjusted by the host site for actions of the user in activities other than those generated through application modules of the invention in the first aspect, are recorded and maintained by the master site in the user's account. This method is initiated by the host WEB site offering the user the opportunity to earn reward points through an action not associated with the application modules already present on the host site. Any points earned by the user through this particular interaction are accumulated by the host site and posted to the point engine located on the master site for maintenance and administration. The user's account is updated and that information is returned to the host site as well as being incorporated into the application modules of the first aspect of the invention.

With the above processes, the application module(s) may be formed from dynamically generated HTML wrapped in a scripting language. Additionally, the interaction by the user with the application module may comprise playing a game of chance or a game of skill presented by the application module, as well as an interaction involving point redemption.

The above and other objects, features and advantages of the invention will become apparent from the following description of the preferred embodiment taken in conjunction with the accompanying drawings.

### BRIEF DESCRIPTION OF THE DRAWINGS

FIG. 1 a is a schematic illustrating the first aspect of the process in the system of the present invention.

FIG. 1b is a schematic illustrating the second aspect of the process in the system of the present invention.

FIG. 2 is a flowchart illustrating the first aspect of the method of delivering and monitoring application modules.

FIG. 3 is a flowchart illustrating the second aspect of the method of providing application modules to a user.

### DESCRIPTION OF THE PREFERRED EMBODIMENTS

The present invention is directed to the creation of application modules that allow for dynamic interactivity with a master site by a user on a host site, involving a user, a host site and a master site, where the master site monitors and maintains account information for the user. The present invention is directed as well to the creation of a point engine interface that is not specifically user interactive but relates to the maintenance of the user's account information with interactivity occurring directly between the user and the host site, after which the host site provides the affected account information to the master site for maintenance and administration.

The following terms and their definitions, as they relate to the present invention are provided.

A host site is preferably a WEB site, where the host site has entered into an agreement with a master site whereby the host site includes an application module in the host site's normal presentation of information, i.e., a WEB page, to users.

An application module is an embedded section of the information presented by the host site that allows for interaction with a user. When the user interacts with the application module, points may be earned or disbursed by the user.

A point engine interface is a section of code provided to the host site for their interaction with the master site with regard to the maintenance of individual users' accounts. This interface is used when the user's points are affected by actions other than those performed within the first aspect of the invention.

The master site, which includes a master server, maintains an accounting of the earned points and can provide different application modules based on the needs and desires of the host site, as well as code to provide an interface with the point engine. The points earned by a user may be redeemed in various ways.

Administration tools are also provided on the master site whereby a host site can maintain and update certain site attributes as dictated by the agreement between the host and master sites.

Identification of the individual member is made possible by the host site providing an arbitrary id code embedded in the application module which is delivered to the user. This unique arbitrary id is created when either the user registered with the host site prior to the implementation of the application module or when a new visitor to the host site decides to interact with an application module, at which time a registration process is initiated. When the user chooses to participate with that application module, the code is transmitted to the master site for verification and recognition.

The application modules comprise scalable programs that may be customized to reflect the unique look and feel of the host WEB sites while increasing brand and product awareness, building customer loyalty and ensuring customer retention. Several types of promotions may be utilized in the application modules. These include sweepstakes held on a daily basis from different categories where members can earn a varying number of points based on the outcome of the sweepstakes. Members can also interact with online “scratch-off tickets,” that allows the user to instantly know that they have won points. Members can use their points to bid on prizes, against other members or use their points to enter higher-level sweepstakes. In addition, members can earn points simply for joining or subscribing to other WEB sites and/or their newsletters. It is understood that the types of application modules having utility with the present invention are not limited by the examples provided above.

The present invention affords host sites the opportunity to develop loyalty and promotional products on their respective WEB sites without requiring the separate implementation and monitoring of those products.

The present invention allows the host sites to take advantage of all the member retention features that the promotional products provide, including a rewards program, online scratch off tickets and online auctioning utilizing earned points.

In addition, part of the present invention offers a collection of pre-designed shared promotions that can be offered to multiple clients' WEB sites. These pooled promotions offer site visitors the chance to win prizes.

Once a relationship is established between the master server and a subscribing host site, the promotions are designed and monitored to help assure that the client's, i.e., host site's, objectives are satisfactorily achieved.

The process of the present invention offers “real-time” results to users. This is accomplished through the use of a scripting language combined with a display language. In a preferred embodiment, the combination of the scripting language with the display language is dynamic HTML wrapped in dynamic scripting language, such as JavaScript. Points are awarded to the user through their actions involving the application modules. The master site maintains the administration of the user's account and provides immediate updates to the user. Important to the ability to provide “real-time” updates of earned points is the point-engine used by the master site's server. The point-engine is essentially a WEB interface which takes in certain information provided by either the user through dynamic interaction or by the host site as a recording device for the addition or deletion of the points. The point-engine is described in greater detail below.

The application modules seamlessly blend into, and have the look and feel of the host site. The implementation process consists of providing the host site with simple cut-and-paste code, which facilitates a rapid turn around time. The application modules are hosted and maintained within the host site by the master site, and are displayed on the host site's WEB pages through the use of dynamically generated HTML wrapped in JavaScript.

The following is an example of how the initial screen shown to user is generated:

The user selects the host site with their browser;

The host site returns a page for display embedded with the calls for the application module(s);

While the page is loading on the user's computer, the application module calls are sent to the master site through “script” calls or through HTML frame calls wrapped in a scripting language, such as JavaScript;

The master site's server processes the call and returns Dynamic JAVA Script and HTML code to the user's computer.

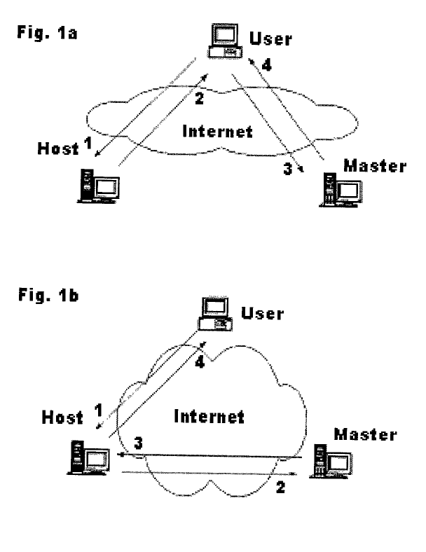

FIG. 1a illustrates this stage of the process. Arrow 1 represents the user requesting a WEB page from the host site. Arrow 2 represents the host site returning a page with embedded application module(s) calls to the user's machine. Arrow 3 represents the application module(s) calls being sent to the master site, while WEB page is being loaded onto the user's machine. The master server processes the calls and returns the application module(s) to the user.

Examples of the type of JavaScript calls, written in pseudocode, used to implement the application module(s) are provided in Table 1.

```
TABLE 1
<!--- PIA CODE SNIPPET --->
*** This goes right under the BODY tag ***
<SCRIPT LANGUAGE=“JavaScript”>
<!--//
var memberid = <<member>>;
if(navigator.appName == “Netscape”)
  {document.write(‘<ilayer src=“<<loyalty engine page that sets user
variable>>?member_id=‘+memberid+’&coid=<<company ID>>”
width=“0” height=“0”></ilayer>’);}
else
  {document.write(‘<iframe src=“<<loyalty engine page that sets user
variable>>?member_id=‘+memberid+’&coid=<<company ID>>”
name=“points_won” width=“0” height=“0” marginwidth=“0”
marginheight=“0” scrolling=“no”
frameborder=“0” style=“visibility: hidden;”></iframe>’);}
//-->
</SCRIPT>
*** This is placed where you want the PIA ***
<SCRIPT LANGUAGE=“JavaScript” SRC=“<<loyalty engine
page that loads PIA>>”></SCRIPT>
<!--- SCRATCHOFF CODE SNIPPET --->
*** This is placed in a pop-up box.
The bottom frame (scratchoff) needs to be
425 in height, so the pop-up box should have dimensions of 500
Width × 425 + (banner frame) Height ***
<SCRIPT>
var memberid = <<member>>;
var bgclr= “<<hex value>>”;
var ticketcolor= “<<hex value>>”;
var fontcolor= “<<hex value>>”;
var rndm_num = (Math.round((Math.random() * 10000)));
document.write(‘<FRAMESET FRAMEBORDER=“0”
FRAMESPACING=“0” BORDER=“0”
ROWS=“<<syndicated banner height>>,*”
OnUnload=“window.opener.location.reload();“>’);
document.write(‘<FRAME SRC=“<<syndicated site's
banner template>>”
NAME=“scratch_header” SCROLLING=“no”>’);
document.write(‘<FRAME SRC=“<<loyalty engine page that loads
scratchoff>>?member_id=‘+memberid+’&coid= <<company ID>>
&bgcolor=‘+bgclr+’&ticketcolor=‘+ticketcolor+’&fontcolor=
‘+fontcolor+’&‘+rndm_num+’” NAME=
“scratch_content” MARGINWIDTH=“0”
MARGINHEIGHT=“0”>’);
document.write(‘</FRAMESET>’);
</SCRIPT>
*** This is placed in a page that will call a custom header,
and the bottom frame will call the syndicated auction code ***
<!--- AUCTION CODE SNIPPET --->
<SCRIPT>
var memberid = <<member>>;
document.write(‘<FRAMESET FRAMEBORDER=“0”
FRAMESPACING=“0” BORDER=“0” ROWS=
“<<syndicated header height>>,*”>’);
document.write(‘<FRAME SRC=“<<syndicated site's header template>>”
NAME=“header” SCROLLING=“no”>’);
document.write(‘<FRAME SRC=“<<loyalty engine's company
specfic auction
page>>?member_id=‘+memberid+’&coid=<<company ID>>”
NAME=“content” MARGINWIDTH=“0”
MARGINHEIGHT=“0”>’);
document.write(‘</FRAMESET>’);
</SCRIPT>
```

The host site may award/adjust points to the user's account for selected actions other than those offered on the initial screen. The communication hierarchy involved in this process is as follows:

An action performed by the user prompts the host site to award/adjust a particular number of points for the user;

The host site posts to the master server with the information generated by the user's action, and other information necessary (Unlike the dynamic interaction between the user and the master site on the initial screen, the posting by the host site may or may not be in “real-time” as determined by the host site; however all actions conducted by the master site after posting are in “real-time”).

The master site verifies the id information of the host site, updates the user's point information and returns the updated user's status to the host site;

The host site may or may not update the user immediately as determined by the host site; however, the updates are immediately available for the user through interaction with an application module.

FIG. 1b illustrates this second stage of the process. Arrow 1 represents the action of the user prompting the host site to award/adjust points. Arrow 2 represents the host site posting to the master site with necessary information. The master site performs a security check and then processes the information received. The user's account is updated and arrow 3 represents the master site sending the user's status information to the host site. The host site can then provide the updated information to the user, as indicated by arrow 4.

An example of the information forwarded to the master site from the host site, written in pseudocode, is provided in Table 2.

TABLE 2
<!--- POINTS ENGINE CALL (CF EXAMPLE) --->
<!---
Parameter List
m = Member ID, Varchar2(255)
i = Company ID
s = Section ID for metrics, Varchar2(20)
v = Value for points, Number(38)
c = Ceiling of Points, Number(38)
d = Date Awarded, Date(7) Based on ISO 8601:1988 Format -
YYYYMMDD&T&HHMMSS i.e.: 19930214T131030
--->
<CFHTTP METHOD=“post” URL=“<<loyalty engine's point
modification template>>”>

<CFHTTPPARAM NAME=“m” TYPE=“FormField”

VALUE=“<<members>>”>

<CFHTTPPARAM NAME=“i” TYPE=“FormField” VALUE=

“<<company ID”>

<CFHTTPPARAM NAME=“s” TYPE=“FormField” VALUE=

“<<reward section>>”>

<CFHTTPPARAM NAME=“v” TYPE=“FormField” VALUE=

“<<points>>”>

<CFHTTPPARAM NAME=“c” TYPE=“FormField” VALUE=

“<<max points allowed>>”>
</CFHTTP>

While the entire process is generated and maintained by the master site, the host site can adjust the look and feel of the application modules through the use of the previously discussed administration tools. The administration tools include a site provided within master site for maintenance of prizes, sponsors, program parameters and graphics.

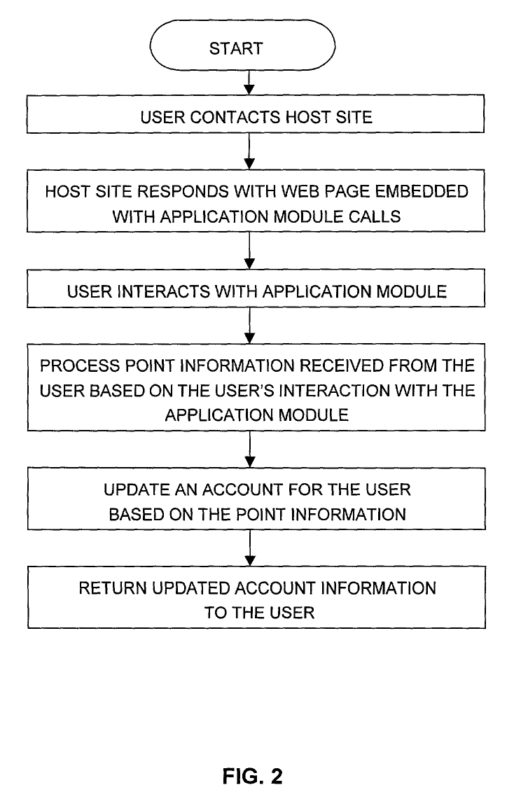

The process followed by the master site will now be discussed with respect to the flowchart illustrated in FIG. 2. The host site is contacted by the user. The user receives a WEB page from the host site that is embedded with application module(s) calls. The calls are made from the user's browser and the application module(s) are displayed seamlessly within the host site's WEB page. If the user interacts with the embedded application module(s), the results of this interaction are immediately sent to the master site for processing within the point engine with the results being displayed to the user in “real-time.”

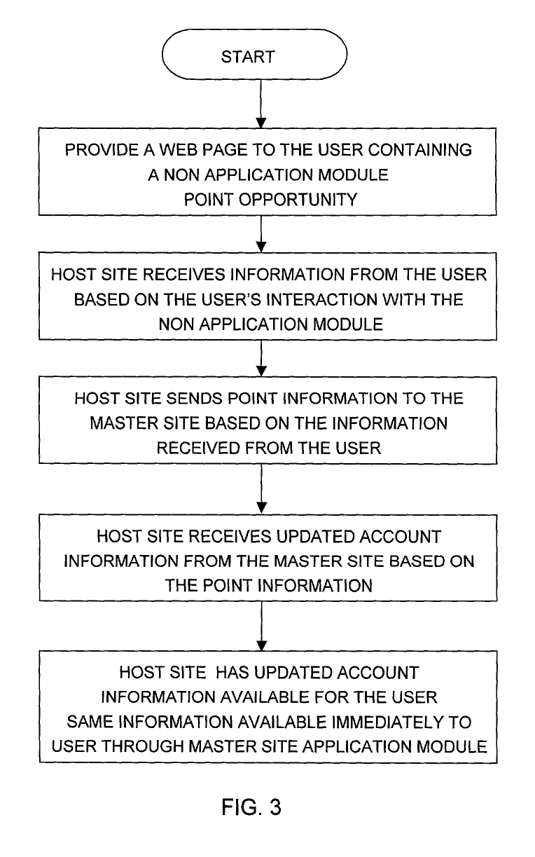

The process followed by the host site will now be discussed with respect to the flowchart illustrated in FIG. 3. The host site awaits a point generating action by a user on a non application module. Upon such action the host site receives information from the user and subsequently the host site sends the same point information to the master site. The master site processes that information and sends the host site updated account information based on the point information. The updated account information may then be returned to the user by the host site. That same information may be accessed by the user through interaction with an application module.

In the preferred embodiment, the process of creating HTML wrapped in dynamic JavaScript, in particular the way the PIA (Personal Information Assistant) is utilized, lends itself to the “real-time” points updates as well as seamlessly integrating the application modules to other WEB sites. The building of JavaScript code dynamically, which in turn produces the correct HTML application module on an external site, solves three major issues:

1. Since the result of the embedded JavaScript is simply HTML, the code becomes compatible with any browser that supports the HTML 4.0 standard (this is a standard that has been used by major WEB browsers) and is not tied to any one browser or browser version.

2. Again, since the result is simply HTML, the source HTML on the external site does not have to look like it originated from master site, but rather have the look and feel of the hosting site.

3. Implementation can be as simple as cutting and pasting very small snippets of JavaScript code onto the external (host) WEB site's pages.

Although embodiments of the present invention have been described in detail, it will be understood that the present invention is not limited to the above-described embodiments, and various modifications in design may be made without departing from the spirit and scope of the invention defined in claims.

For example, while above discussion has specifically addressed the use of JavaScript and HTML, the present invention is not limited to the use of those standards. Other scripting and display standards may also be used.

Similarly, while the above discussion has focused on the use of a single master site, the present invention may be practiced with a plurality of master sites, as long as there is coordination between those master sites.

In a most preferred embodiment, invention will be linked via a global computer network such as the Internet or World Wide WEB, but other embodiments including LANs, WANs and intranets, fulfill the spirit and scope of the present invention. Both employer and employee systems will typically comprise any device that connects to the system via the Internet or other IP transport methods and includes, but is not limited to, such devices as televisions, computers, hand-held devices, cellular phones, land based telephones, wireless electronic devices and any device which uses a transport medium. Non-limiting examples of a transport medium applicable for use in the present invention comprise any backbone or link such as an ATM link, FDDI link, satellite link, cable, cellular, twisted pair, fiber optic, broadcast wireless network, the Internet, the World Wide WEB, local area network (LAN), wide area network (WAN), or any other kind of intranet environment such a standard Ethernet link. In such alternative cases, the clients will communicate with the system using protocols appropriate to the network to which that client is attached. All such embodiments and equivalents thereof are intended to be within the scope of the present invention.

What is claimed is:

1. A method of delivering and monitoring application modules, said method comprising the steps of:
receiving a request from a host site's WEB page for an application module, where a user interacts with said application module to earn points; processing said request;
returning said application module to said user;
receiving point information from said user based on the user's interaction with said application module;
processing said point information and updating an account for the user based on said point information; and
returning updated account information to said user.

2. A method of delivering and monitoring application modules according to claim 1, wherein said step of returning said application module comprises returning an application module comprised of dynamically generated HTML wrapped in a scripting language.

3. A method of delivering and monitoring application modules according to claim 1, wherein said step of receiving point information comprises receiving point information based on the user playing a game of chance presented by said application module.

4. A method of delivering and monitoring application modules according to claim 3, wherein said step of receiving information comprises receiving information from a plurality of users, each interacting with a respective application module by playing said game of chance.

5. A method of providing application modules to a user through a WEB site, said method comprising the steps of:
awaiting a WEB page request from a user;
providing a WEB page to said user, upon request, with said WEB page containing a request to a master site for an application module, where the user interacts with the application module to earn points.

6. A method of providing application modules to a user through a WEB site according to claim 5, wherein said step of providing a WEB page comprises providing a WEB page having the request to the master site for the application module with the application module comprised of dynamically generated HTML wrapped in a scripting language.

7. A method of providing application modules to a user through a WEB site according to claim 5, wherein said user interacts with the application module by the user playing a game of chance presented by said application module .

8. A method of providing application modules to a user through a WEB site according to claim 7, wherein said step of providing a WEB page comprises providing WEB pages to a plurality of users, where each of said plurality of users interacts with a respective application module by playing said game of chance.

9. A method of interacting with application modules, comprising the steps of:
requesting a WEB page from a host site;
receiving said WEB page, with said WEB page containing a request to a master site for an application module;
interacting with said application module to earn points;
sending information to said master site based on said interaction with said application module, where said information is related to the points earned; and
receiving updated account information, related to the said points earned, from said master site.

10. A method of interacting with application modules, according to claim 9, wherein said application module comprises dynamically generated HTML wrapped in a scripting language.

11. A method of interacting with application modules, according to claim 9, wherein said step of interacting with said application module to earn points comprises playing a game of chance presented by said application module.

12. A method of updating a user's account information with a point engine interface comprising the steps of:
receiving information from a host site related to a change in the user's account as a result of a user interaction;
processing information from said host site based on said interaction, where said information is related to a change in a number of points in a user's account; and
sending updated account information, related to said change in the number of points, to said host site.

13. A method of updating a user's account information with a point engine interface, according to claim 12, wherein said step of receiving information from a host site comprises receiving information that is not related to the user's interaction with an application module.

14. A method of interacting with said point engine, according to claim 12, wherein said step of returning updated information to the host site further comprises providing an application module with dynamically generated HTML wrapped in a scripting language to provide an update to said user.

15. A system comprising:
a user node having a browser program connected to a network;
a host content provider having a WEB site responsive to requests for information from said user node to provide content and a request for an application module; and
a master server responsive to a request from said user node for the application module, where said master server maintains account information for a user at said user node;
wherein said user node is configured such that when the user node interacts with the application module through actions of the user, the user earns points, and balances of said points are maintained by said master server.

16. A system according to claim 15, wherein the application module comprises dynamically generated HTML wrapped in a scripting language.

17. A system according to claim 15, wherein the application module is configured to present a game of chance to the user at said user node.

18. A system according to claim 17, wherein said host content provider and the application module are configured to present said game of chance to a plurality of users at a plurality of user nodes.

19. A system comprising:
a user node means having a browser program connected to a network;
a host content providing means responsive to requests from said user node means to provide point update processing for interactions within said host content providing means; and
a master serving means responsive to said host content providing means, where said master serving means maintains and updates account information for a user in a point engine maintained within said master serving means, and returns updated account information to said host content providing means;
wherein, said interactions within said host content providing means are unrelated to interactions between the user and an application module and said user node means is configured such that when the user node means interacts with the host content providing means, said host content providing means interacts with the master serving means to receive a point balance for the user.

20. A system according to claim 19, wherein the host content providing means provides said point balance to said user node.
